(19) United States
(12) Patent Application Publication
(10) Pub. No.: US 2002/0116241 A1
(43) Pub. Date: Aug. 22, 2002

(54) Enterprise resource planning system for ordering, tracking and shipping goods from a seller to a buyer

(76) Inventors: Virender Sandhu, Ann Arbor, MI (US); Ravikumar N. Samandur, West Bloomfield, MI (US); Karen L. Scherer, Dearborn, MI (US); Adrian Ray Toccoli, Chihuahua (MX); Olaf Bacher, Raisdorf (DE); Robert Gembler, Bonn (DE)

Correspondence Address: Steven M. Hays, Artz & Artz, PC, Suite 250, 28333 Telegraph Road, Southfield, MI, 48034, US

(21) Appl. No.: 09/790,060

(22) Filed: Feb. 21, 2001

(51) Int. Cl. G06F 17/60

(52) U.S. Cl. 705/7; 705/26; 705/28; 705/29

(57) ABSTRACT

An updateable enterprise resource planning system to coordinate and reconcile a seller's, a buyer's, a supplier's and a third party logistic supplier's business systems into a single updateable central system hosted by a seller. The seller is provided with information to forecast, plan, and coordinate present and future purchases in a timely and efficient manner. The buyer, seller, and third party logistics supplier are also provided with updated information to use to ship product to the buyer in a timely and efficient manner. A second aspect of the present invention provides the buyer with access to a web server controlled by the seller, wherein the buyer can link up with a third party logistic supplier web site coupled to said web server to monitor shipping status of the shipping orders. This allows the buyer to facilitate planning for arrival of shipments to improve efficiency, leading in potential cost savings. Further, depending upon the information gleaned as to the shipping status, the buyer can modify the original purchase order to either increase, maintain, or decrease the amount of product or goods shipped to maintain an adequate inventory.

### TECHNICAL FIELD

The present invention relates generally to the ordering, tracking and shipping of goods between a buyer and seller and more particularly to an enterprise resource planning system for ordering, tracking and shipping goods from a seller to a buyer.

### BACKGROUND

The process of order tracking is an important component in the success of both a seller's business and a buyer's business. This is especially true as just-in-time business practices become more and more common. Precise order tracking is necessary to properly schedule personnel and equipment in an efficient and cost effective manner.

Prior to the advent of the computer age, this process was extremely inefficient with a large paper trail. Buyers typically submitted purchase orders to sellers, who then directed their suppliers or warehouses to ship the necessary product to the buyers. To track orders, buyers would need to contact the sellers, who would in turn contact their suppliers or warehouses to get an update on the status or delivery of the shipment.

Many problems resulted in this process. For example, the time required to process the purchase orders, submit requests to suppliers or warehouses, confirm/update inventories or produce necessary parts, assign carriers, ship the parts between suppliers and warehouses, check the parts in or out based on these orders, and eventually ship the parts to the buyer was a cumbersome and inefficient process. Further, order modifications such as whether to change the ordered amount of product or change the delivery time based on the shipping forecast was a difficult process. Also, buyers had difficulty tracking the location of purchase orders at various points before final shipment between the suppliers, third party logistics suppliers (i.e. warehouses or distribution centers) in order to accurately determine when the shipments would arrive at the proper buyer facility.

With the advent of the computer age, some of these concerns were minimized or eliminated. For example, inventory control was improved. Further, assignment of carriers and scheduling of shipping of the products were streamlined.

One problem that has not been addressed is the ability of a buyer to efficiently track the orders from initial purchase order through delivery. Another issue not addressed was the ability of buyers to be able to modify purchase orders based on shipping order status.

It is thus highly desirable to allow the buyer of product to be able to monitor the progress of the shipment of their orders at all time from start to finish. It is also highly desirable for buyers to be able to modify purchase orders quickly based on the status of their current shipping orders. This would allow buyers the ability to maintain inventory at the most efficient level possible and to properly schedule personnel and equipment in an efficient and cost-effective manner.

### SUMMARY OF THE INVENTION

It is an object of the present invention to create a system for ordering, tracking (both inventory and orders) and shipping goods from a buyer to a seller.

It is another object of the present invention to provide a method in which a buyer or purchaser can monitor the processing of purchase orders with third party logistics suppliers to enable buyers to efficiently and cost-effectively schedule personnel and equipment for use. This also allows buyers to modify purchase orders based upon the representations of third party logistics suppliers to ensure that appropriate amounts of the products that are the subject of the purchase orders are maintained at all times.

The present object is accomplished by creating an enterprise resource planning (“ERP”) system to integrate buyers, sellers, suppliers, and third party logistics suppliers (“3PL's”) business practices into a single, coherent system. The ERP keeps track of purchase orders, shipping, and inventory to ensure that a buyer receives the goods or services requested from a seller in a timely and efficient manner. The ERP also is used by the seller to forecast and maintain inventory levels to ensure that adequate supplies of inventory are available to cover future orders.

Buyers are allowed to monitor a seller's web server to receive updates as to the status of buyer's purchase orders. The seller's web server is in communication with the third party logistic supplier's website that is updated regularly with information about the status of purchase orders. Buyers can instantaneously receive information to properly schedule personnel and equipment for use of the product that is the subject of the purchase order, resulting in higher efficiency and cost savings. In addition, this monitoring allows buyers to modify purchase orders by increasing or decreasing the amount of product purchased as a function of their monitoring of the status of purchase orders.

Other objects and advantages of the present invention will become apparent upon considering the following detailed description and appended claims, and upon reference to the accompanying drawings.

### BRIEF DESCRIPTION OF THE DRAWINGS

FIG. 1 is a general schematic of a business relationship having a buyer, seller, supplier, and third party logistics supplier;

FIG. 2 is a logic flow diagram for ordering, tracking and shipping goods from a seller to a buyer; and

FIG. 3 is a logic flow diagram illustrating how a buyer may track a purchase order on a computer with the seller and third party logistics supplier.

### DESCRIPTION OF THE PREFERRED EMBODIMENT(S)

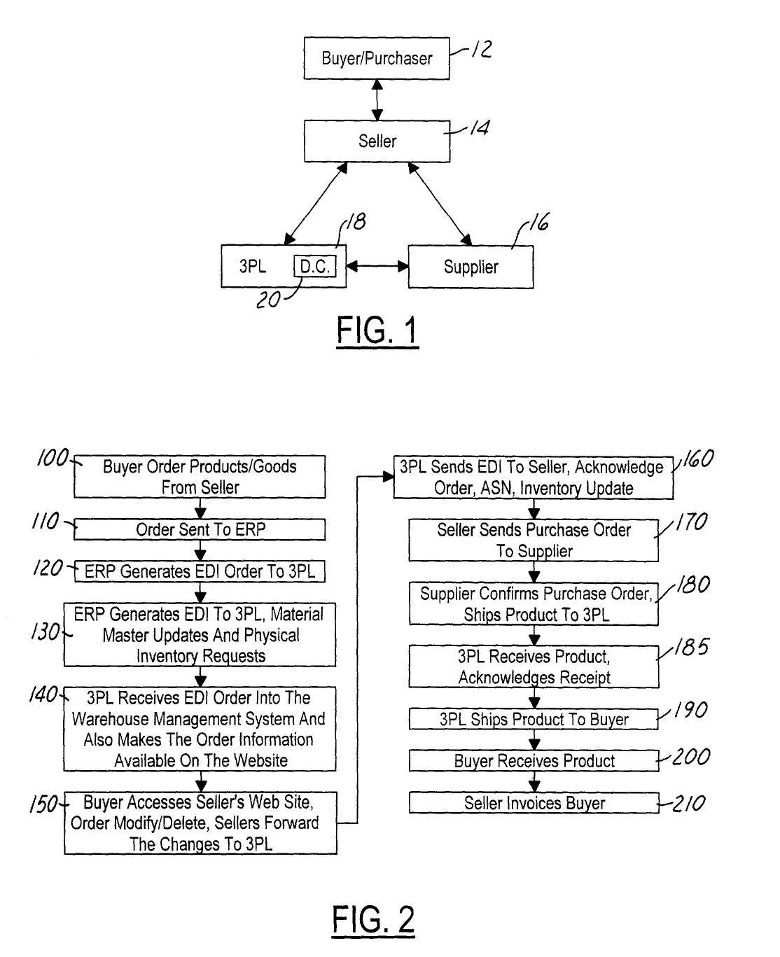

Referring now to FIG. 1, a typical business relationship 10 is illustrated having a buyer 12, seller 14, supplier 16, and a third party logistics supplier 18. The supplier 16 and third party logistics supplier 18 may be a portion of the seller's company or independent suppliers to the seller 14. The third party logistics supplier 18, or 3PL, typically has distribution centers 20, or warehouses, that are used to store seller's products prior to shipping.

To place an order, buyer 12 places an order with seller 14 for a product. The seller 14 then contacts the 3PL 18 to determine the available inventory of the product within the distribution centers 20. If the 3PL 18 has the inventory, arrangements are made to ship the product to the buyer 12. If the 3PL 18 does not have the inventory, the seller 14 contacts supplier 16, who will produce the product and send the product directly to buyer 12, or 3PL 18, or both. In addition, arrangements are typically made to replace the inventory by placing a purchase order with the supplier 16. The seller 14 will typically place a purchase order forecasting the amount of a particular product that the seller 14 forecasts needing for a predetermined period to ensure that they will be able to fill orders. Supplier 16 then typically produces the product and ships the product to the distribution centers 20 as directed by seller 14 for storage until needed.

Referring now to FIG. 2, a logic flow diagram for ordering, tracking, and shipping goods from a seller 14 to a buyer 12 according to the present invention is displayed. First, in Step 100, a buyer 12 communicates an order to the seller 14. This can be accomplished via phone, fax, email, the seller 14 web server, or any other type of communication vehicle, including electronic data interchange (“EDI”), as contemplated in the art. Next, in Step 110, orders based on the buyer's 12 requirements are generated through one of the methods in Step 100 and sent to an Enterprise Resource Planning (“ERP”) system. The ERP system is a software system used to integrate business systems or practices into one central system. In the present invention, the ERP is used to coordinate and reconcile the seller's, buyer's, supplier's, and 3PL's computer system into one central system which is used to notify and update each individual component.

Next, in Step 120, the ERP generates an EDI concerning the new order that is sent to a third party logistics supplier (“3PL”). The 3PL 18 is a transportation and warehousing supplier for the seller's 14 company. In Step 130, the ERP generates an EDI to the 3PL 18 regarding physical inventories requests and material master updates believed to be held by the 3PL 18 for the seller 14.

In Step 140, the 3PL 18 receives the EDI from Step 130 and loads information pertinent to the buyer 12 regarding the order on a computer database that is linked to the 3PL's 18 internet website which is accessible through the seller's 14 web server. This information may include, but is not limited to, order status, distribution center assignment, carrier assignment, and shipping information.

In Step 150, the buyer 12 can review the information of Step 140 by accessing the information through the seller's 14 web server. Based upon this information, the buyer 12 can accept, modify or delete an order based upon the information provided. This modification could include changing the amount of product sent, shipping date, or other relevant information. If changes are made to the order, this information can be sent via an EDI or by any other available communication method to the seller 14, wherein the information is sent via an EDI to the 3PL 18. The 3PL 18 can then reenter information onto their website. This process can continue until the buyer 12 is satisfied with the order.

In Step 160, the 3PL 18 sends an EDI back to the seller 14 acknowledging the order information. In addition, the 3PL 18 sends to the seller 14 an advance shipping notification (ASN), shipping information, packaging/picking information, EDI physical inventory counts, and updates information regarding stock reconciliation.

In Step 170, a purchase order will be sent to a supplier 16 as a function of the orders created in Step 110 as well as a forecast of potential orders for a predefined period for all potential customers and the amount of available inventory as determined by the 3PL 18 in Step 130. This helps to ensure that the 3PL 18 has an adequate supply of product within its warehouses and distribution centers to ship to buyers 12 on a timely basis.

In Step 180, the supplier 16 will confirm receipt of the purchase order by sending an advance ship notification (“ASN”) and invoice to the seller 14, while shipping the requested product to the 3PL 18. In Step 185, the 3PL 18 acknowledges receipt of the shipped produce from the supplier 16.

In Step 190, the 3PL 18 ships the requested product to the buyer 12. The 3PL 18 will also update information regarding the shipment of the requested product onto the 3PL 18 Internet website accessible to the buyer 12.

In Step 200, the buyer 12 receives the shipment, reviews it for completeness and damage, and sends an EDI to the seller 14 regarding the shipment. Based upon the representations in Step 200, the seller 14 than invoices the buyer 12 in Step 210 for the order amount less offsets for incompleteness or damage.

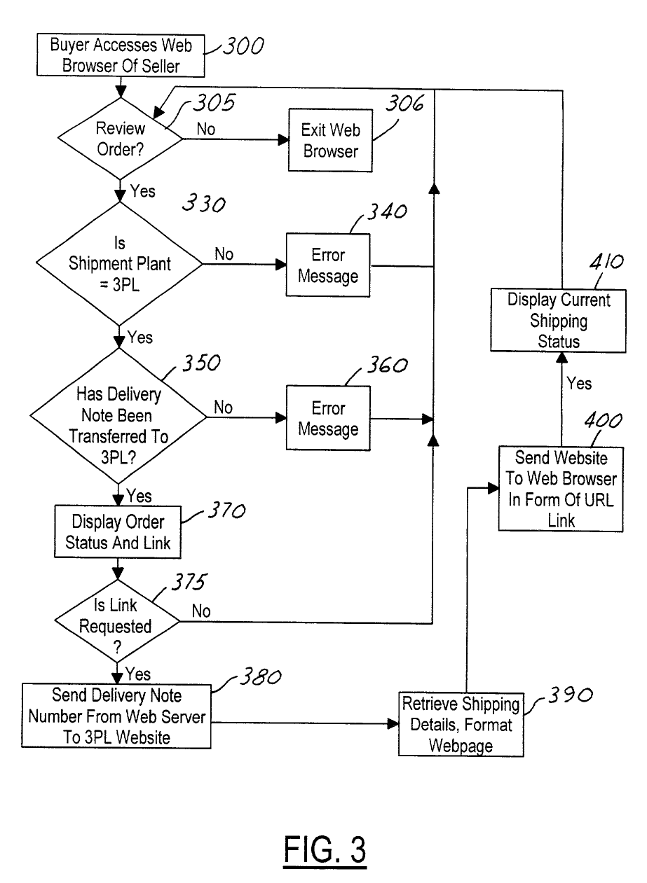

FIG. 3 is a flow chart depicting how a buyer 12 can access the 3PL 18 website via the seller's 14 web server to obtain information regarding a particular order. In Step 300, the buyer 12 accesses the seller's 14 web server. Next, in Step 305, the buyer 12 is asked whether they wish to enter the tracking system. If they do not, exit the web browser in Step 306, otherwise proceed to Step 330.

In Step 330, a determination is made as to whether the shipment delivery plant is the 3PL 18. If it is not, a message is indicated in Step 340 indicating that 3PL 18 is not the party shipping the product. The buyer 12 is then directed back to the main screen of Step 305 to check on other orders. If the shipment plant is the 3PL 18, proceed to Step 350.

In Step 350, a determination is made to determine whether a delivery note has been transmitted to the 3PL 18. If not, a message is sent to the buyer 12 in Step 360 indicating that a delivery note has not been sent. The buyer 12 is then directed back to the main screen of Step 310 to check on other orders. If a delivery note has been transmitted, the order status is displayed in Step 370. In addition, a display link is displayed for inquiring about shipping details. If the shipping details display link is requested by the buyer 12 in Step 375, Step 380 sends a delivery note number to the 3PL 18 internet. If the shipping displays link is not requested, return to Step 305. In Step 390, the 3PL 18 internet website retrieves the shipping details based on this delivery note number and formats a web page for the delivery note. The delivery note web page is then sent to the buyer's 12 computer in the form of a URL (Uniform Resource Locator) link in Step 400. The URL link may be requested by the buyer 12 in to display the current shipping status from the 3PL 18 Internet website in Step 410. After the shipping status is displayed, the buyer 12 is directed back to the main screen of Step 305 to inquire as to other orders.

The present invention offers two interrelated methods for creating, tracking, processing, monitoring and shipping orders between sellers and buyers. First, the present invention incorporates the business systems of sellers, buyers, 3PL's and suppliers into a single, comprehensive enterprise resource planning system. This ERP system is used to update shipping orders, track inventories, forecast future purchase orders, and update information regarding distribution of orders.

Further, the present invention provides a method in which information concerning orders is accessible by a buyer 12 through a seller's 14 web server that is connected with a 3PL's 18 internet. In this way, a buyer 12 can access information regarding order status to properly plan for utilizing the ordered product in an efficient and cost-effective manner. At the same time, sellers 14 and 3PL's 18 can limit the access of the buyer 12 to particular orders for security reasons. Further, sellers 14, suppliers 16, and 3PLs 18 can use the information provided to efficiently and cost-effectively order, produce, warehouse and ship product.

While the invention has been described in terms of preferred embodiments, it will be understood, of course, that the invention is not limited thereto since modifications may be made by those skilled in the art, particularly in light of the foregoing teachings. For example, the present invention may be utilized for multiple suppliers 16 and/or 3PLs 18, depending upon the size of the companies involved and the number of ultimate destinations of product that is the subject of a purchase order prior to ultimate delivery to a buyer 12.

What is claimed is:

1. A method for tracking a purchase order between a buyer and a seller having a third party logistics supplier, the method comprising the steps of:
providing a third party logistic supplier website having an updateable information site regarding the purchase order;
coupling said third party logistic supplier website to a web server, wherein said web server is controlled by the seller;
providing the buyer access to said updateable information site through said web server, wherein the buyer may track the purchase order by obtaining a plurality of information from said updateable information site.

2. The method of claim 1, wherein the step of providing the buyer access to said updateable information site through said web server comprises the step of providing the buyer access to said updateable information site through said web server, wherein the buyer may track the purchase order by determining whether the third party supplier is the delivering plant for the purchase order from said updateable information site.

3. The method of claim 2 further comprising the step of determining whether a delivery note has been transmitted to the third party supplier from said seller if it is determined that the third party supplier is the delivering plant for the purchase order.

4. The method of claim 3 further comprising the steps of:
displaying an updated order status from the third party supplier regarding the purchase order; and
displaying a link for shipping details when said delivery not has been transmitted to the third party supplier.

5. The method of claim 4 further comprising the step of switching the display of a computer screen to said third party supplier website to display a shipping status for the purchase order when said link for shipping details is selected by the buyer.

6. The method of claim 5 further comprising the step of modifying the purchase order as a function of said shipping status.

7. A method wherein a buyer of a product or goods from a seller can monitor the progress of the production and shipment of the product or goods with a third party supplier to determine whether to increase, decrease or hold constant the amount of product to be shipped, the method comprising the steps of:
accessing a web server controlled by the seller, wherein said web server is coupled with a third party supplier website controlled by the third party supplier;
determining whether the third party supplier is the delivering plant for the product or goods;
determining whether the third party supplier has received a delivery note from the seller if the third party supplier is the delivering plant; and
determining whether the third party supplier has scheduled a shipping date if the third party supplier has received said delivery note.

8. The method of claim 7, wherein the step of determining whether the third party supplier has scheduled a shipping date if the third party supplier has received said delivery note comprises the step of determining whether the third party supplier has scheduled a shipping date as a function of a plurality of scheduling factors if the third party supplier has received said delivery note.

9. The method of claim 8, wherein the step of determining whether the third party supplier has scheduled a shipping date as a function of a plurality of scheduling factors if the third party supplier has received said delivery note as a function of a plurality of scheduling factors comprises the step of determining whether the third party supplier has scheduled a shipping date if the third party supplier has received said delivery note, wherein said plurality of scheduling factors is selected from the group consisting of the buyer requested shipping date, the amount of inventory of the products or goods available within a plurality of distribution centers, the availability of carriers to deliver the products or goods to the buyer, and the amount of product or goods needed to be delivered to said plurality of distribution centers by a supplier.

10. A method for improving communications between buyers and sellers regarding the purchase, tracking, and shipment of a seller's product to a buyer, the method comprising the steps of:
providing an enterprise resource planning system hosted by the seller that is accessible by the buyer, supplier and third party logistics supplier, said enterprise resource planning system used to coordinate and reconcile the seller's, the buyer's, a supplier's, and a third party logistics supplier's computer system into a coordinated central system;
updating said enterprise resource planning system with information from the buyer relative to the purchase, tracking, and shipment of the seller's product to the buyer;
updating said enterprise resource planning system with information from a supplier's business system relative to the purchase, tracking, and shipment of the seller's product to the buyer; and
updating said enterprise resource planning system with information from a third party logistics supplier's business system relative to the purchase, tracking, and shipment of the seller's product to the buyer.

11. The method of claim 10, wherein the step of updating said enterprise resource planning system with information from the buyer relative to the purchase, tracking, and shipment of the seller's product to the buyer comprises the step of:
providing said enterprise resource planning system with a new buyer request, said new buyer request selected from the group consisting of a new purchase order, a modified purchase order, and a goods receipt advice notification.

12. The method of claim 10, wherein the step of updating said enterprise resource planning system with information from a supplier's business system relative to the purchase, tracking, and shipment of the seller's product to the buyer comprises the step of:
providing said enterprise resource planning system with a new supplier request, said new supplier request selected from the group consisting of a supplier advance shipping notification and a supplier invoice.

13. The method of claim 10, wherein the step of updating said enterprise resource planning system with information from a third party logistics supplier's business system relative to the purchase, tracking, and shipment of the seller's product to the buyer comprises the step of:
providing said enterprise resource planning system with a new third party logistic supplier's request, said new third party logistic supplier's request selected from the group consisting of a purchase order acknowledgement, an advance shipping notification, a shipper, a physical inventory count, a material masters update, and a stock reconciliation list.

14. The method of claim 10 further comprising the steps of:
coupling said enterprise resource planning system with a seller browser, said seller browser accessible to said buyer;
coupling a third party logistic supplier internet website with said seller browser, said third party logistic supplier internet website being accessible to the buyer through said seller browser to provide order tracking information via an order tracking information site.

15. The method of claim 14, wherein said order tracking information site contains information regarding a status of a purchase order, said status selected from the group consisting of whether a distribution center has been assigned, whether a carrier has been assigned, and an estimated time of arrival of the product that is the subject of said purchase order.
